(19) United States
(12) Patent Application Publication
(10) Pub. No.: US 2026/0067838 A1
(43) Pub. Date: Mar. 5, 2026

(54) RESTRICTED PEER SYNCHRONIZATION

(71) Applicant: APPLE INC., Cupertino, CA (US)

(72) Inventors: Yong Liu, Campbell, CA (US); Charles F. Dominguez, San Carlos, CA (US); Tashbeeb Haque, San Francisco, CA (US); Lawrie Kurian, Cupertino, CA (US); Su Khiong Yong, Palo Alto, CA (US)

(21) Appl. No.: 19/306,095

(22) Filed: Aug. 21, 2025

Related U.S. Application Data
(60) Provisional application No. 63/689,510, filed on Aug. 30, 2024.

(51) Int. Cl. H04W 56/00

(52) U.S. Cl. CPC H04W 56/002

(57) ABSTRACT

Embodiments herein may restrict peer synchronization for Wi-Fi peer-to-peer communication when a low-latency data link is established. A first wireless device in a first cluster may operate a latency-sensitive application. The first wireless device may receive a beacon frame from a transmitter (TX) wireless device in a second cluster. The beacon frame may include a TX restricted synchronization filter (RSF) attribute. Based on compatibility of the TX RSF attribute being with the first wireless device's own RX RSF, the first wireless device may adopt or decline to adopt a clock of the TX wireless device and merge with the second cluster.

### TECHNICAL FIELD

This application relates generally to wireless communication systems, including synchronization between wireless communication devices for peer-to-peer communication.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and the Institute of Electrical and Electronics Engineers (IEEE) 802.11 standard for Wireless Local Area Networks (WLAN) (commonly known to industry groups as Wi-Fi®).

In the 802.11 standard for WLAN, an access point (AP) is a device that creates a wireless local area network (WLAN), or Wi-Fi® network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi® protocol. Various protocols have been established to increase security over a wireless communication network. For example, Simultaneous Authentication of Equals is the core authentication protocol of WPA3-Personal, and is mandated to be supported by all Wi-Fi® Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit (or digits) in a reference number refers to the figure number in which that element is first introduced.

FIG. 1A illustrates an example of a first cluster and a second cluster, in accordance with some embodiments.

FIG. 1B illustrates an example in which device B joins cluster X and is in discoverable distance to device C, in accordance with some embodiments.

FIG. 2 illustrates an example of two synchronization domains for cluster X and cluster Y of FIG. 1A and FIG. 1B, in accordance with some embodiments.

FIG. 3 demonstrates an example scenario involving two attacking devices targeting a Wi-Fi® P2P network cluster, in accordance with some embodiments.

FIG. 4 illustrates an example network diagram in which device B and device D do not synchronize with neighboring clusters and devices based on a restricted peer synchronization protocol, in accordance with some embodiments.

FIG. 5 illustrates a neighbor awareness networking (NAN) beacon, in accordance with some embodiments.

FIG. 6 illustrates an example Bloom Filter transmitted in a beacon, in accordance with some embodiments.

FIG. 7 illustrates an example network diagram 710 in which restricted peer synchronization is implemented, in accordance with some embodiments.

FIG. 8 illustrates two example states of a network using restricted peer synchronization where a device changes the services that it is operating, in accordance with some embodiments.

FIG. 9 illustrates an example network diagram where both cluster X and cluster Y are operating the same service in the same house, in accordance with some embodiments.

FIG. 10 illustrates an example of synchronized jumping, in accordance with some embodiments.

FIG. 11 illustrates an example method performed by a receiver (RX) wireless device (e.g., a device that receives a beacon), in accordance with some embodiments.

FIG. 12 illustrates an example method performed by a transmitter (TX) wireless device (e.g., a device that sends a beacon), in accordance with some embodiments.

FIG. 13 illustrates an example system for performing signaling between a wireless device and a network device, according to embodiments disclosed herein.

### DETAILED DESCRIPTION

Various embodiments are described with regard to station (STA) devices.

However, reference to an STA is merely provided for illustrative purposes. The example embodiments may be utilized with any electronic component that may establish a connection to a network and is configured with the hardware, software, and/or firmware to exchange information and data with the network. Therefore, the STA as described herein is used to represent any appropriate electronic component.

Wi-Fi® Peer-to-Peer (P2P) technologies, such as Wi-Fi® Aware and Wi-Fi® Direct, allow devices to communicate with each other without a Wi-Fi® access point or internet connection. It enables peer-to-peer connections between devices like smartphones, tablets, and computers, allowing them to share data, stream media, and perform other tasks directly without requiring an intermediary network. Traditional Wi-Fi® signaling may result in a delay in the data as the first device transmits data to an access point and then the access point transmits the data to the second device. Wi-Fi® P2P connections may reduce the delay as the communication link is between devices.

Also, if there is no access point within an area, Wi-Fi® P2P may allow two devices to transmit data to each other. Wi-Fi® P2P enables mobile phones, cameras, printers, PCs, and gaming devices to create their own Wi-Fi® networks without an internet connection. Devices can make a one-to-one connection, or a group of several devices can connect simultaneously. When the devices make a connection with one or more devices, they form a cluster.

For Wi-Fi® P2P connections, the devices synchronize their timing with other devices operating in a cluster. Different clusters may operate using different clocks. A clock for each cluster may be referred to as a synchronization domain. The synchronization domain ensures that all devices in the cluster are operating on the same timing schedule, allowing them to communicate efficiently and without conflicts.

When a device joins a cluster, the device synchronizes with the clock of the cluster. The clock of the cluster is determined by the device with the highest rank within the cluster (called Anchor Master in the Wi-Fi® Aware standard specification). For example, a device may receive a beacon from a device that includes timing information for a synchronization domain of a cluster. If the device decides to join the cluster, the device may adopt its timing according to the timing information in the beacon to synchronize with the cluster.

However, a delay in data transmission may result when clusters merge. The delay may cause issues for low-latency applications such as audio and video. For instance, audio and video glitches may be caused by cluster merging. Embodiments herein provide systems, methods, and apparatuses to prevent or minimize such glitches for low-latency applications when the clusters merge.

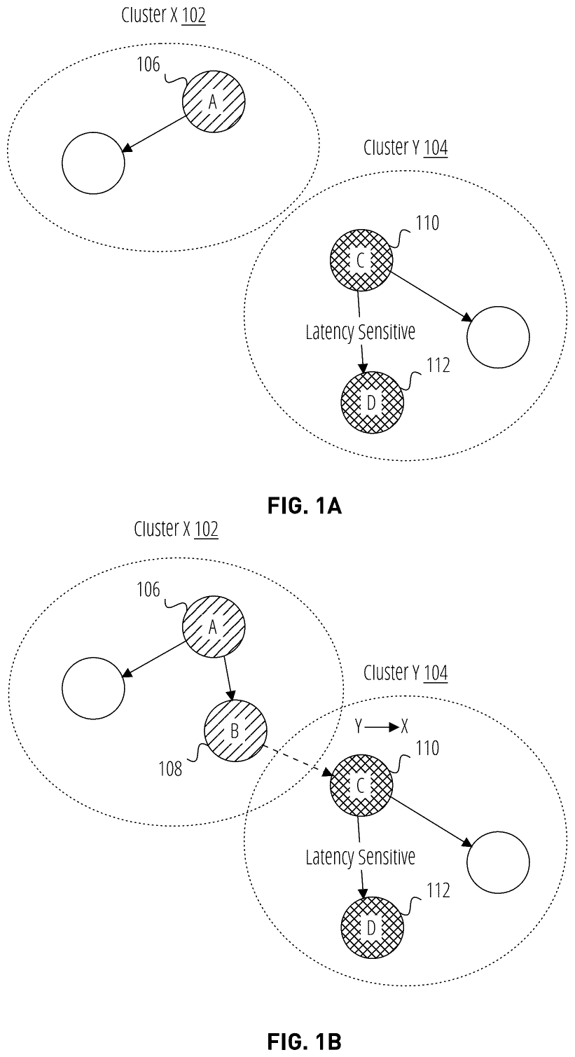

FIG. 1A and FIG. 1B illustrate a scenario where two clusters merge. Specifically, FIG. 1A illustrates an example of a first cluster (e.g., cluster X 102) and a second cluster (e.g., cluster Y 104) in accordance with some embodiments. Cluster X 102 and cluster Y 104 are separated by a distance that prevents the devices within each cluster from discovering each other. Cluster X 102 may have a greater grade than cluster Y 104. As shown, cluster X may include device A 106 and one or more other devices, and cluster Y 104 may include device C 110 and device D 112 and one or more other devices.

Devices within a cluster may maintain time synchronization with other devices in the same cluster. In the example illustrated herein, cluster X 102 and cluster Y 104 have different synchronization domains. That is, the clocks for the devices in cluster X 102 have different timing than the devices in cluster Y 104.

As shown, in cluster Y 104, device C 110 and device D 112 may establish a connection to support a low-latency application. For example, device C 110 may be streaming video and/or audio to device D 112. Device C 110 and device D 112 may try to ensure that time sensitive data is delivered on time to prevent glitches in the low-latency application. However, a delay may be introduced if device C 110 merges with cluster X 102. The delay may cause a glitch. Device C 110 may decide to join cluster X 102 if a device in cluster X 102 comes within a discoverable range of device C 110.

FIG. 1B illustrates an example in which device B 108 joins cluster X 102 and is in discoverable distance to device C 110, in accordance with some embodiments. When device B 108 is added to cluster X 102, device C 110 is able to see cluster X 102 and because they are in different synchronization domains the two clusters merge to a single cluster so that they can all synchronize to each other.

Device C 110 and device D 112 were originally members of cluster Y 104. Device C 110 was the Anchor Master of cluster Y 104. Accordingly, device D 112 synchronizes to the clock of device C 110. Device D 112 also maintains an active low-latency data link with device C 110.

Device C 110 may join cluster X 102. However, if current standards are used, the low-latency data link may be impacted. For example, in some embodiments, when device C 312 discovers a new cluster (Cluster X 102) via Device B 108 and finds the Cluster Grade (CG) of cluster X 102 is higher than the CG of cluster Y 104, device C 110 immediately joins cluster X 102 by adopting and synchronizes to device B's clock. The new clock (Time Synchronization Function (TSF)) adopted by device C 110 changes the time positions of device C's discovery windows (DWs) and Availability Windows (AWs). Device C 110 then may start to send beacons within its new discovery windows, which are no longer aligned with device D's discovery windows. If device D 112 cannot re-synchronize to device C's clock (or Cluster X's clock), device D 112 loses the alignment of DWs and AWs (and corresponding operations channels) with device C 110. In such a situation, device D 112 will not be able to continue data communication with device C 110. Even if device D 112 manages to join cluster X 102 eventually (e.g., through other nearby devices), the low-latency data link between device D 112 and device C 110 is significantly impacted.

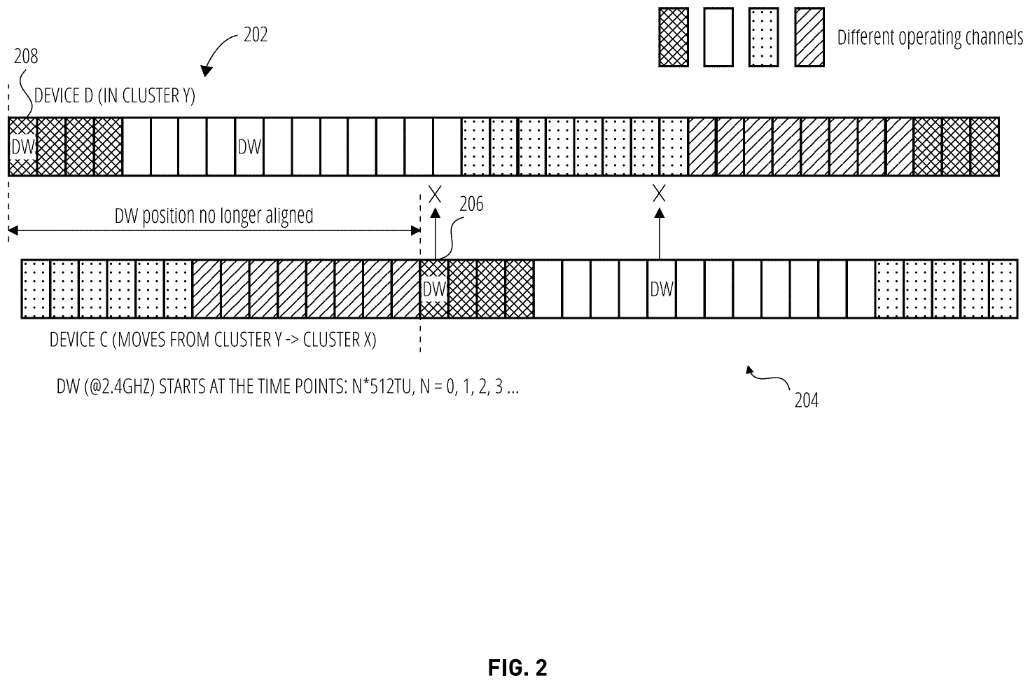

FIG. 2 illustrates an example of two synchronization domains for cluster X 102 and cluster Y 104 of FIG. 1A and FIG. 1B, in accordance with some embodiments. As shown, the operating channel timeline 202 for device D 112 when it is using the clock of cluster Y 104 may have a different alignment than the operating channel timeline 204 of device C 110 when it moves from the clock of cluster Y 104 to the clock of cluster X 102.

As shown, the discovery windows of the operating channel timeline 202 and operating channel timeline 204 are no longer aligned. Instead, the discovery window 206 of device C 110 occurs after the discovery window 208 of device D 112. This misalignment may interrupt the low-latency data link between the devices. The low-latency data link between the devices may not be recovered until device D 112 merges with cluster X 102 also, which may take several hundreds of milliseconds resulting in glitches in the low-latency application (e.g., video or audio stuttering).

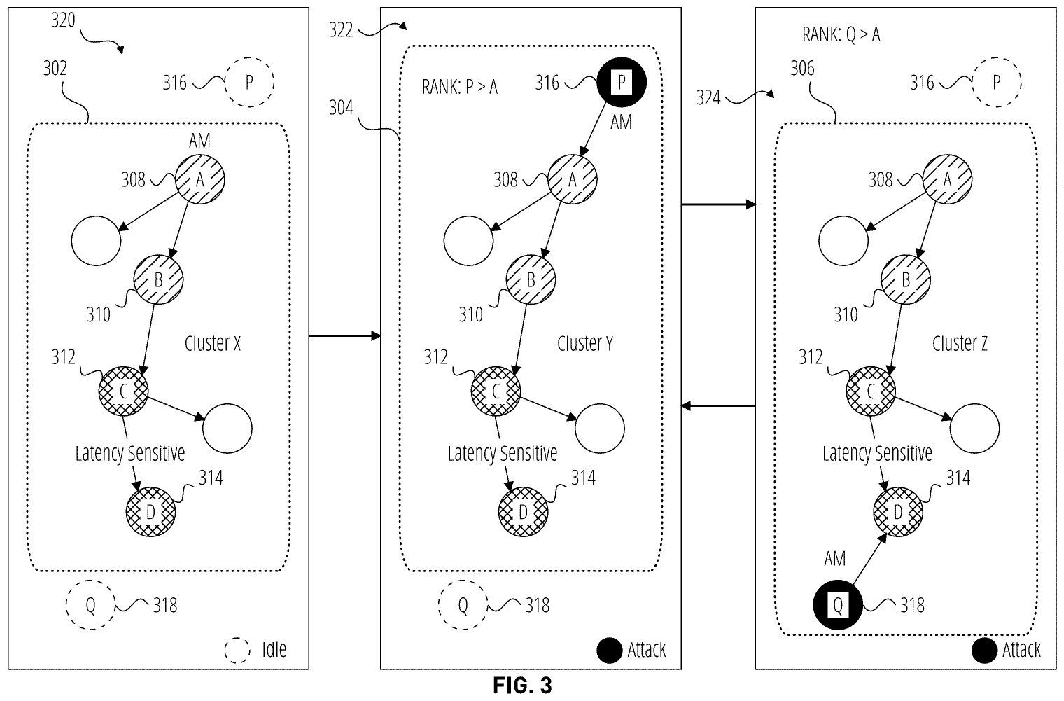

The cluster merging procedure may also cause the devices to be susceptible to attacks. FIG. 3 demonstrates an example scenario involving two attacking devices (device P 316 and device Q 318) targeting a Wi-Fi® P2P network cluster. The attacking devices may cause synchronization disorientation by a denial of service (DOS) attack. This attack causes oscillation in the synchronization of device clocks within the cluster by alternating active and idle states between both attackers.

In an initial state 320, the attacking devices are idle. In the initial state 320, all the devices (e.g., device A 308, device B 310, device C 312, and device D 314) are synchronized with each other and form cluster X 302.

Then in a second state 322 a malicious device (e.g., device P 316) can intentionally create a new cluster (e.g., cluster Y 304) with a very high CG to draw victim devices to merge to the new cluster and follow device P's clock. Device P 316 may have a greater rank than the previous anchor master of cluster X 302 (e.g., device A 308) to force the merging. Accordingly, the devices would shift their timing to synchronize to the clock device P 316.

After a short while, another malicious device (device Q 318) creates another new cluster (e.g., cluster Z 306) to re-synchronize victim devices to device Q's clock. Device P 316 may return to idle, and the rank of device Q 318 may be greater than the other devices causing it to be the new anchor master. Accordingly, in this third state 324, the devices' clocks shift again to synchronize with device Q 318. An attacker can turn device P 316 and device Q 318 on and off alternatively and frequently to mess up victim devices' clocks, misalign their DWs/AWs, and eventually disable their data links with peers.

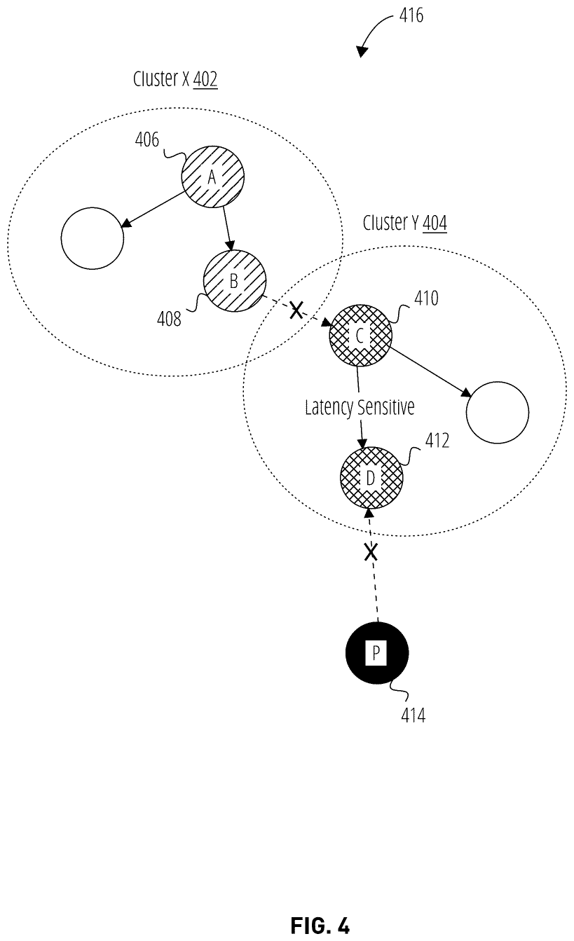

In some wireless communication systems, the synchronization of devices is based on ranking, such that clusters merge whenever devices are in discoverable range based on a ranking system. In some embodiments, restricted peer synchronization may be used to prevent disruption of latency sensitive applications. FIG. 4 illustrates an example network diagram 416 in which device B 408 and device D 412 do not synchronize with neighboring clusters (e.g., cluster X 402) and devices (e.g., device P 414) based on a restricted peer synchronization protocol, in accordance with some embodiments. Restricted peer synchronization may allow a device to decline the adoption of a peer's clock (TSF) or decline joining a new cluster based on restricted synchronization policies, disregarding the peer's rank, cluster ID, and cluster grade.

For example, in some embodiments a device may not adopt a peer's clock if the peer device is advertising or seeking service(s) which are not relevant to the service(s) being operated by the device. For instance, device C 410 may not adopt the clock of device B 408. Device C 410 and device D 412 may operate a latency sensitive service (e.g., audio or video streaming), and device B 408 and device A 406 may operate a file sharing service. As the file sharing service is not relevant to audio/video streaming, device C 410 may decline to join cluster X 402 and maintain cluster Y 404, despite device A 406 having a greater rank than device C 410.

In some embodiments, a device may not adopt a peer's clock, if the peer does not belong to a restricted synchronization group. The group can be bounded by a group ID and/or group key. For example, device D 412 may not adopt the clock of device P 414 despite device P 414 having a greater rank than device C 410 because device P 414 does not have the same group ID and/or group key.

In some embodiments, a device may apply the restricted synchronization criteria when it is conducting critical operations with one or multiple peers. For example, when a device is running active low-latency data paths with one or multiple peers, the device may apply the restricted synchronization criteria (e.g., not adopt a peer's clock based on services, group ID, and/or group key). When the device is not conducting critical operations, the device may apply synchronization policies based on peer's rank, cluster ID, and cluster grade.

In some embodiments, restricted peer synchronization may be implemented based on elements within a beacon. For example, a device may receive a beacon, decode the beacon, and determine elements of that beacon that are associated with attributes of services, groups, or devices. Based on the current state of the device and the elements in the beacon, the device may choose whether or not to synchronize with the beacon transmitting device.

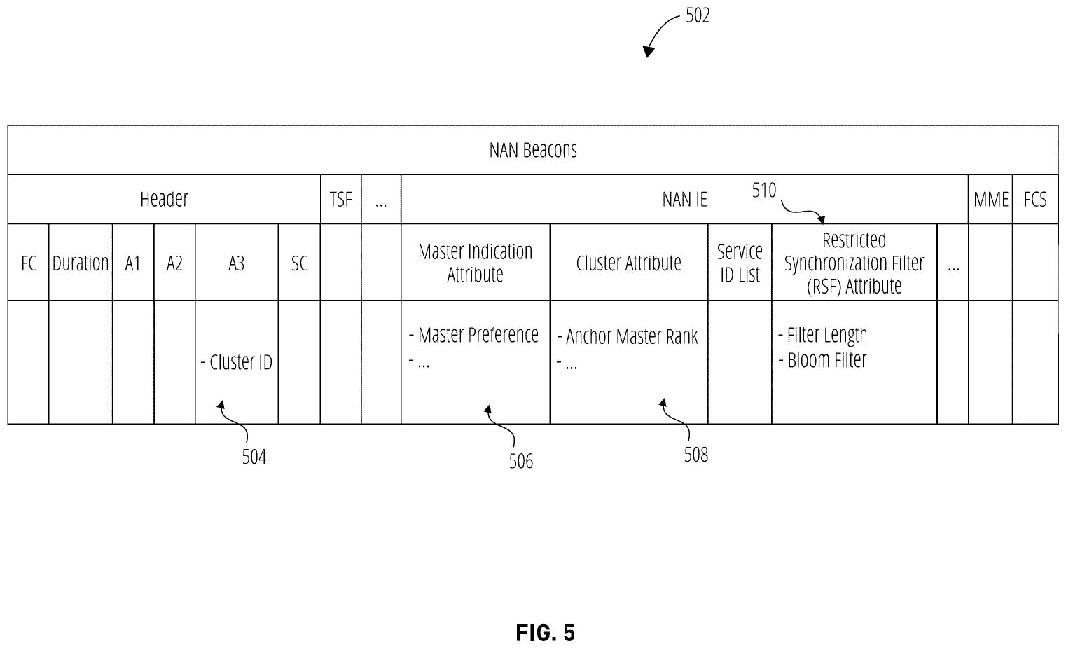

For example, FIG. 5 illustrates a neighbor awareness networking (NAN) beacon 502, in accordance with some embodiments. As shown, the NAN beacon 502 may include a cluster ID 504, a master indication attribute 506, and an anchor master rank 508. These features may be used by a receiving device to determine whether to synchronize with the transmitting device.

Further, the NAN beacon 502 may include a restricted synchronization filter attribute element 510. The restricted synchronization filter attribute element 510 may be used by a device that is operating under a restricted peer synchronization policy. For example, the device that receives the NAN beacon 502 may synchronize with the transmitting device if the anchor master rank 508 is higher than the rank of the anchor master of the current cluster and the restricted synchronization filter attribute element 510 meets certain conditions.

In some embodiments, the restricted synchronization filter attribute element 510 may include a filter length and a Bloom Filter. The Bloom Filter is a data structure that is used to test whether an element is a member of a set. For example, the Bloom Filter may provide positioning of a bit array, and that positioning may correspond to a specific service, group, and/or device. Based on the Bloom Filter, the receiving device may determine whether to synchronize with the transmitting device.

The Bloom Filter element of the restricted synchronization filter attribute element 510 may be a service specific element. A service specific element may enable a peer device to synchronize to devices running a same service. For instance, in some embodiments, if a device is operating a video streaming service, the device may synchronize to a transmitting device when the Bloom filter corresponds to the video streaming service. The service specific element can be the name of a supported or operating service (e.g., service 1 name, service 2 name, etc.).

The Bloom Filter element of the restricted synchronization filter attribute element 510 may be a group specific element. The group specific element may enable a peer device to identify and synchronize to devices within a certain group. The group specific element can be a group ID, a group identity key, or both (e.g., group 1 ID and/or group 1 identity key, group 2 ID and/or group 2 identity key, etc.).

The Bloom Filter element of the restricted synchronization filter attribute element 510 may be a device specific element. A device specific element may enable a peer device to identify and synchronize to a known device. A device specific element can be a device name/ID, a device identity key, or both (e.g., device name/ID and/or Device identity key).

In some embodiments, the Bloom Filter element may be fixed. However, having a fixed element may result in attackers being able to copy the element and/or track the device. Accordingly, in other embodiments, a security and privacy enhanced Bloom Filter element may be used. In the enhanced Bloom Filter element, each element can include a key and/or a nonce to provide security and privacy protection. For example, a service specific element may include a Service Name, Group or Device Identity Key, Nonce. A group specific element may include Group ID, Group Identity Key, Nonce. A device specific element may include Device Name, Device Identity Key, Nonce. In some embodiments, the Nonce can be the clock (TSF) or partial clock value, or an increasing or random number included in the RSF attribute.

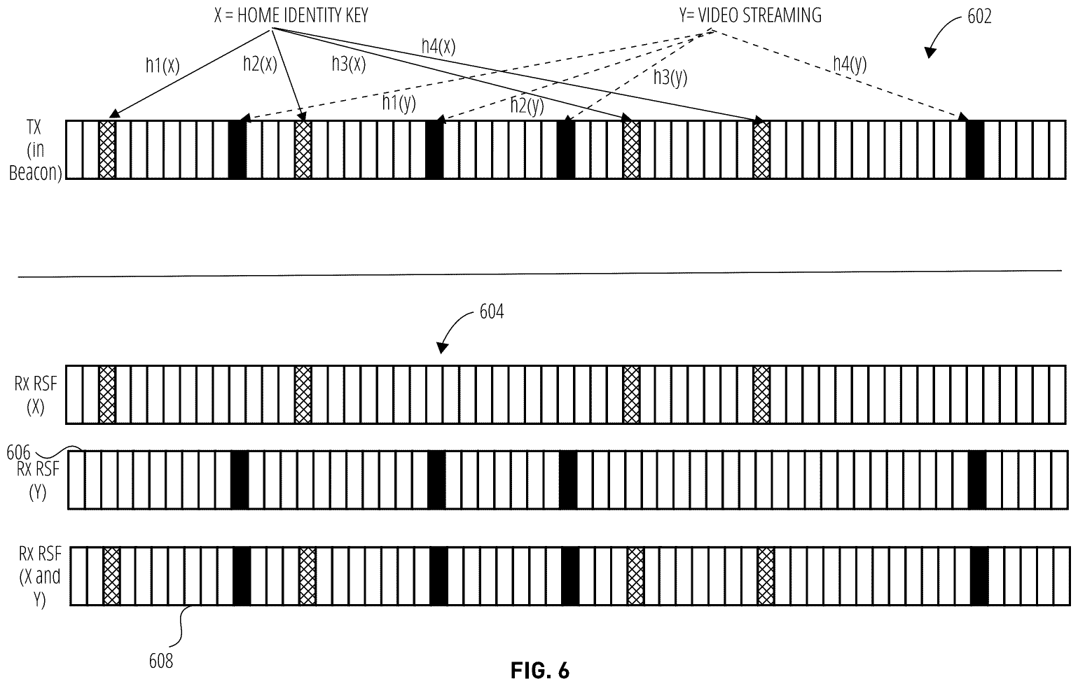

FIG. 6 illustrates an example Bloom Filter 602 transmitted in a beacon in accordance with some embodiments. The Bloom Filter 602 may comprise a bit array where hash functions position the bits in the array. In the illustrated embodiment, the Bloom Filter 602 indicates support for home identify key and video streaming. A receiving device may filter beacons based on a Restricted Synchronization Filter (RSF). For example, some devices may use an RSF 604 that restricts the receiving device to synchronizing with peer devices that support the home identity key. Some devices may use an RSF 606 that restricts the receiving device to synchronizing with peer devices that support the video streaming service. Some devices may use an RSF 608 that restricts the receiving device to synchronizing with peer devices that support both the home identity key and the video streaming service.

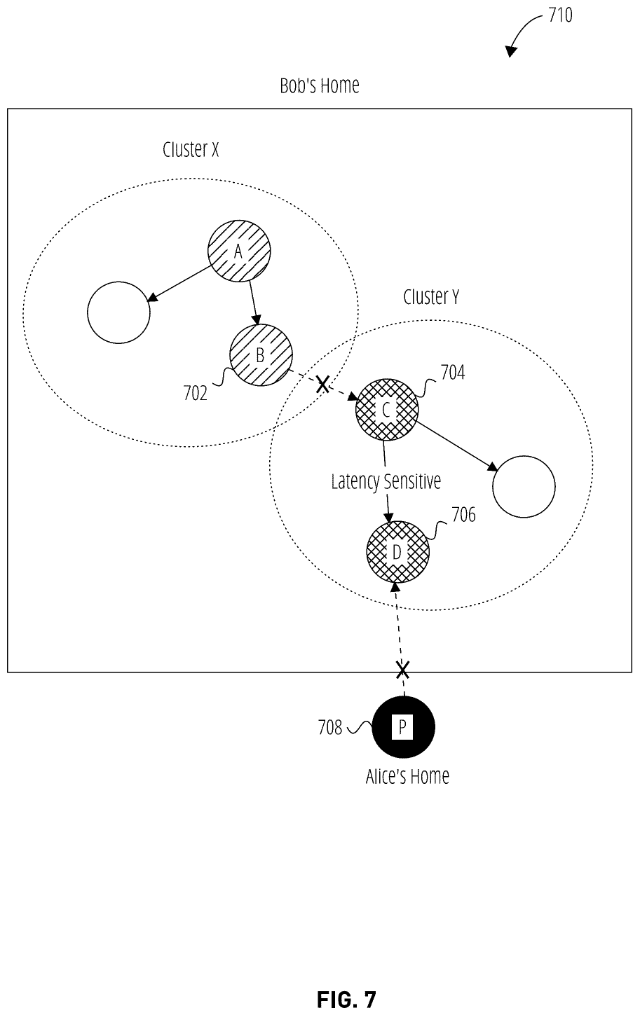

FIG. 7 illustrates an example network diagram 710 in which restricted peer synchronization is implemented in accordance with some embodiments. In the illustrated example embodiment, the RSF in beacons from device B 702 beacons may include the following Bloom Filter elements: Device Identity Key, Home Identity Key, and a service name (e.g., file sharing).

When device C 704 and device D 706 have not yet established a data path to support a low-latency service (e.g., video streaming), they may configure a receiving side RSF with the following Bloom Filter elements to cause synchronization with paired peers or any peer in a same home. The receiving side RSF Bloom Filter elements may include any cached Device Identity Keys or a Home Identity Key. The home identity key may correspond with a user's home (e.g., Bob's home), and the device identity keys may be associated with peer devices that the device has previously paired with. In this state, device C 704 can synchronize to device B 702 (in a same home), but device D 706 does not synchronize to device P 708 (which does not possess the home identity key).

After device C 704 and device D 706 establish an active data path to support a low-latency service (e.g., video streaming), they may configure a RX side RSF with the following elements for synchronization with peers in the same home and running the same low-latency service. The receiving side RSF Bloom Filter elements may include both the Home Identity Key, and the Video streaming service (as a service name). In such a state, device C 110 no longer synchronizes to device B 702, and device D 706 does not synchronize to device P 708.

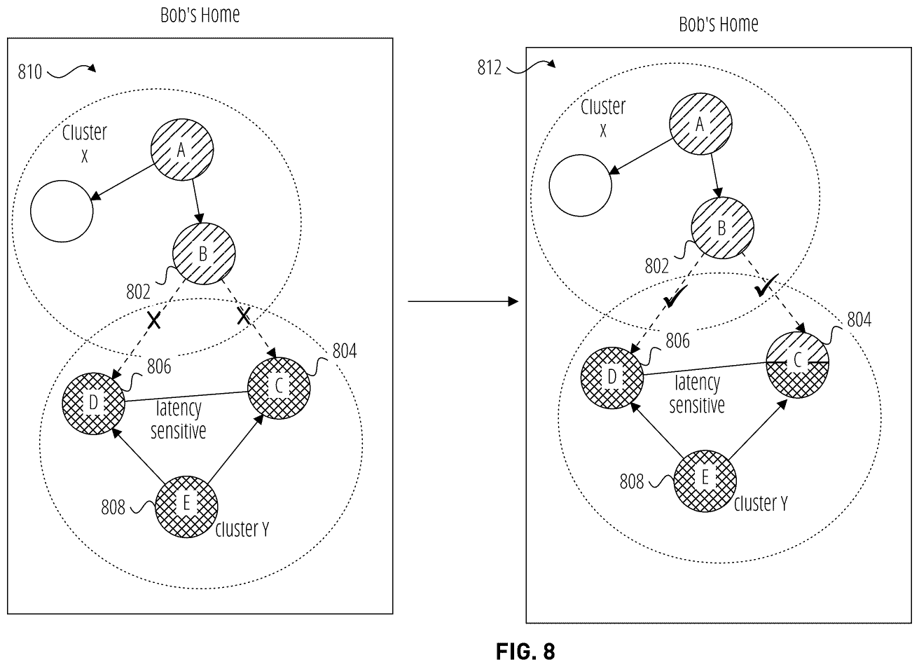

FIG. 8 illustrates two example states of a network (e.g., first state 810 and second state 812) using restricted peer synchronization where a device changes the services that it is operating in accordance with some embodiments. In the first state 810, device C 804 runs active data paths with device D 706 and device E 808 to support a low-latency service (e.g., video streaming). In the first state 810, device C 804 sets its receiver (RX) side RSF to include both Home ID and video streaming Bloom Filter elements. If device C 804 sends beacons, it includes both Home ID and video streaming Bloom Filter elements in the RSF of its beacons. Device B 802 sends beacons with Home ID and file sharing Bloom Filter elements. Accordingly, in the first state 810, device C 804 and device D 806 do not merge with device B 802.

In the second state 812, device C 804 launches a new service (e.g., file sharing) and wants to connect to device B 802. To support both the low-latency service (e.g., video streaming) and the new service (e.g., file sharing), device C 804 may remove the video streaming element from its RX side RSF, so that it can synchronize to device B 802 and join cluster X. Further, device C 804 may send synchronization beacons and/or discovery beacons, disregarding its role/state, and notify device D 806 and device E 808 to merge to cluster X together. Special Bloom Filter elements or special indications in the RSF attribute of beacons may be used by device C 804 to explicitly cancel a certain Bloom Filter element, cancel all service specific elements, and/or cancel all group specific elements from device D's and device E's RX RSF.

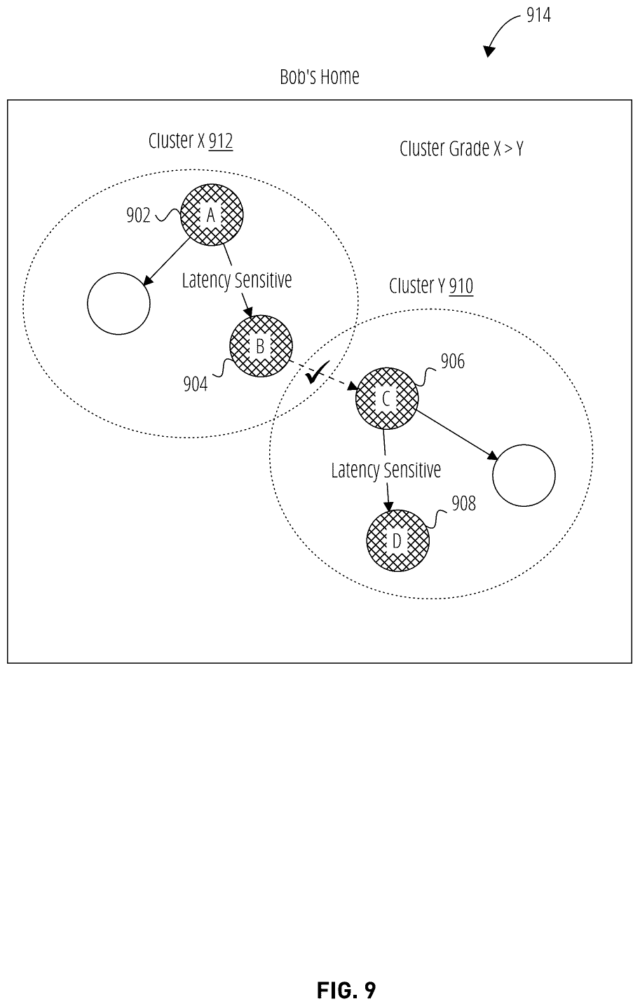

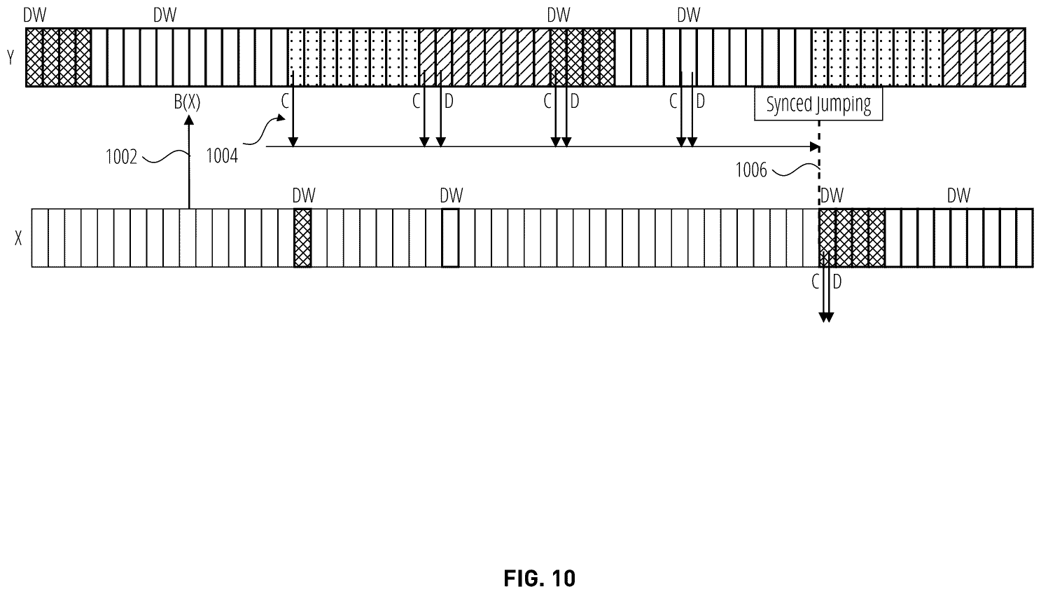

FIG. 9 and FIG. 10 illustrate an example of a cluster merging enhancement that may be introduced to merge multiple devices with a cluster at the same time. Specifically, FIG. 9 illustrates an example network diagram 914 where both cluster X 912 and cluster Y 910 are operating the same service in the same house in accordance with some embodiments. In the illustrated example, device B 904 joins cluster X 912 and begins sending beacons for cluster X 912. Device C 906 receives the beacons from device B 904. As the grade for cluster X 912 is greater than that of cluster Y 910, device C 906 should join cluster X 912.

In this example, restricted peer synchronization does not prevent cluster merging and DW/AW misalignment. For example, both device C 906 and device D 908 start a low-latency service first, and after a while, device A 902 and device B 904 also start the same low-latency service. Per restricted synchronization policies, device C 906 still needs to join cluster X 912 and adopt device B's clock.

To avoid delay and glitches in the low-latency service between device C 906 and device D 908, device C 906 and device D 908 may synchronize their merging time with cluster X 912. Both device C 906 and device D 908 may merge with cluster X 912 at a synchronized jump point.

FIG. 10 illustrates an example of synchronized jumping in accordance with some embodiments. As shown, a beacon 1002 from device B 904 may be received. Device C 906 may continue operating using the clock of cluster Y 910 for a period and periodically transmit beacons 1004 to indicate the merging cluster and synchronized merging time to device D 908 and other devices in cluster Y. Device D may follow the synchronized merging with device C and also transmit beacons to other devices in cluster Y. Then, at a synchronized jump point 1006, both device C 906 and device D 908 (as well as other informed devices in cluster Y) may change their clock together to align with device B's clock and begin transmitting beacons in the DW according to the new clock.

To perform synchronized jumping, in some embodiments, when device C 906 discovers a new cluster (e.g., cluster X 912) and decides to join/merge to the new cluster, device C 906 picks a jumping time point. In some embodiments, the jumping time point can be a subsequent DW starting time of the new cluster (e.g., cluster X 912), for example. Device C 906, disregarding its role/state at cluster Y 910, can send both synchronization beacons and discovery beacons to indicate the new cluster (cluster X 912) it will join and the jumping time point.

The frequent beacons from device C 906 can give device D 908 and other devices in the neighborhood a heads-up about its next move. If device D 908 has an active low-latency data path with device C 906, device D 908 can join cluster X 912 together with device C 906 at the same jumping time point. Device D 908 can also send both synchronization beacons and discovery beacons (disregarding its role/state) to indicate the new cluster (e.g., cluster X 912) it will join and the jumping time point.

In some embodiments, device C 906 may also send additional beacons in the operating channels (other than the discovery channels) running low-latency data paths, or send a Schedule Update Next Available Frequency (NAF) frame (with the synchronized cluster jumping information) to peers individually, to ensure all peers with low-latency data paths with device C 906 merge to the new cluster (e.g., cluster X 912) at the same jumping time point.

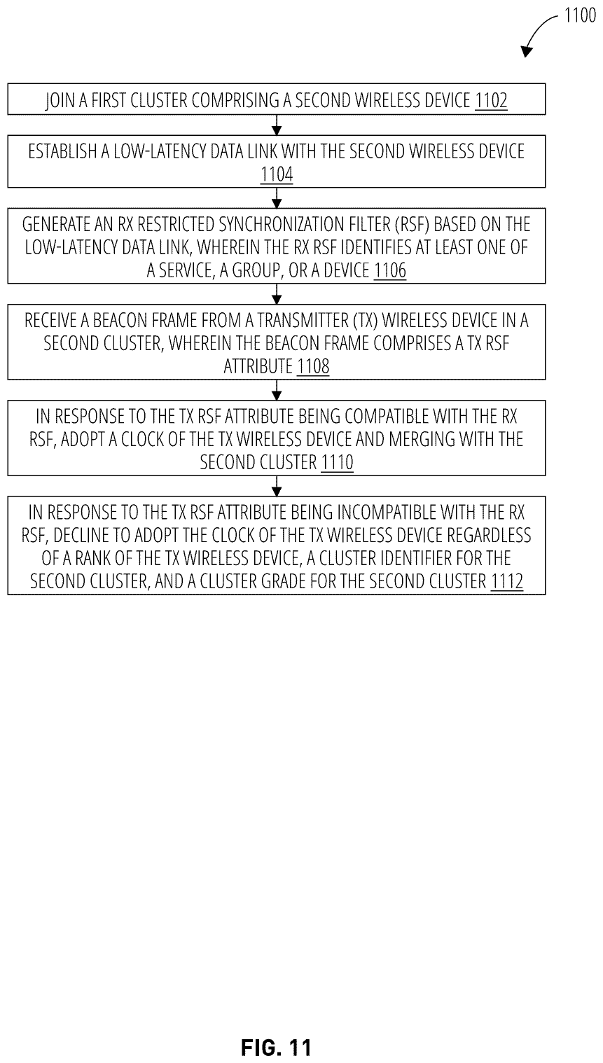

FIG. 11 illustrates an example method 1100 performed by a receiver (RX) wireless device (e.g., a device that receives a beacon), in accordance with some embodiments. The illustrated method 1100 includes joining 1102 a first cluster comprising a second wireless device. The illustrated method 1100 further includes establishing 1104 a low-latency data link with the second wireless device. The illustrated method 1100 further includes generating 1106 an RX restricted synchronization filter (RSF) based on the low-latency data link, wherein the RX RSF identifies at least one of a service, a group, or a device. The illustrated method 1100 further includes receiving 1108 a beacon frame from a transmitter (TX) wireless device (e.g., a device that transmits a beacon) in a second cluster, wherein the beacon frame comprises a TX RSF attribute. The illustrated method 1100 further includes adopting 1110, in response to the TX RSF attribute being compatible with the RX RSF, a clock of the TX wireless device and merging with the second cluster. The illustrated method 1100 further includes declining to adopt 1112, in response to the TX RSF attribute being incompatible with the RX RSF, the clock of the TX wireless device regardless of a rank of the TX wireless device, a cluster identifier for the second cluster, and a cluster grade for the second cluster.

In some embodiments of the method 1100, the TX RSF attribute comprises a filter length and a Bloom Filter element.

In some embodiments of the method 1100, the Bloom Filter element comprises at least one of a service name, a group identifier (ID), a group identity key, a device name, a device ID, or a device identity key.

In some embodiments of the method 1100, the Bloom Filter element further comprises Nonce.

In some embodiments of the method 1100, the Nonce can be the clock or partial clock value, or an increasing or random number included in the TX RSF attribute.

In some embodiments, the method 1100 further comprises launching a new service, wherein the new service is indicated in the beacon frame as being performed in the second cluster, wherein the new service is different than a prior service, the RX wireless device was performing in the first cluster; removing the prior service from the RX RSF to cause the RX RSF to be compatible with the TX RSF; and sending at least one of synchronization beacons or discovery beacons notifying the second wireless device of an intent to merge to the second cluster.

In some embodiments, the method 1100 further comprises picking a jumping time point, wherein the jumping time point comprises a time at which the RX wireless device will adopt the clock of the TX wireless device and merge with the second cluster; sending both synchronization beacons and discovery beacons to indicate the second cluster and the jumping time point to the second wireless device; and merging with the second cluster at the jumping time point.

In some embodiments of the method 1100, the jumping time point is a discovery window starting time of the second cluster.

In some embodiments, the method 1100 further comprises sending additional beacons in operating channels running low-latency data paths to indicate the second cluster and the jumping time point, or sending a Schedule Update Next Available Frequency frame to indicate the second cluster and the jumping time point.

Embodiments contemplated herein include an apparatus comprising means to perform one or more elements of the method 1100. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of an STA (such as a memory 1306 of a wireless device 1302 that is an STA, as described herein).

Embodiments contemplated herein include an apparatus comprising logic, modules, or circuitry to perform one or more elements of the method 1100. This apparatus may be, for example, an apparatus of an STA (such as a wireless device 1302 that is an STA, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of an STA (such as a wireless device 1302 that is an STA, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of an STA (such as a processor(s) 1304 of a wireless device 1302 that is an STA, as described herein). These instructions may be, for example, located in the processor and/or on a memory of the STA (such as a memory 1306 of a wireless device 1302 that is an STA, as described herein).

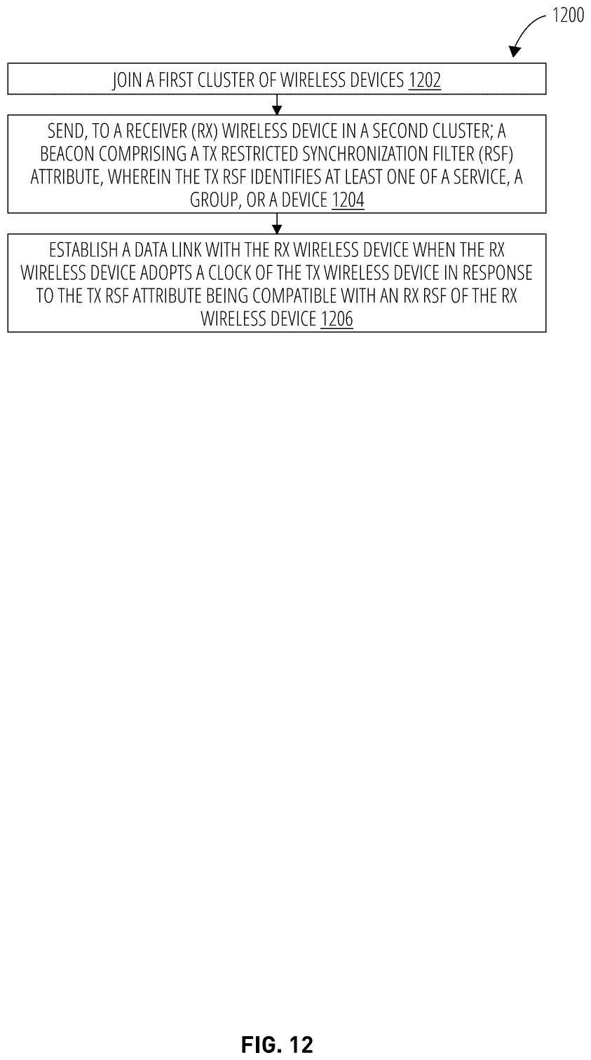

FIG. 12 illustrates an example method 1200 performed by a transmitter (TX) wireless device (e.g., a device that sends a beacon), in accordance with some embodiments. The illustrated method 1200 comprises joining 1202 a first cluster of wireless devices. The method 1200 further comprises sending 1204, to a receiver (RX) wireless device in a second cluster, a beacon comprising a TX restricted synchronization filter (RSF) attribute, wherein the TX RSF identifies at least one of a service, a group, or a device. The method 1200 further comprises establishing 1206, a data link with the RX wireless device, when the RX wireless device adopts a clock of the TX wireless device in response to the TX RSF attribute being compatible with an RX RSF of the RX wireless device.

In some embodiments of the method 1200, the TX RSF attribute comprises a filter length and a Bloom Filter element.

In some embodiments of the method 1200, the Bloom Filter element comprises at least one of a service name, a group identifier (ID), a group identity key, a device name, a device ID, or a device identity key.

In some embodiments of the method 1200, the Bloom Filter element further comprises Nonce.

In some embodiments of the method 1200, the Nonce can be the clock or partial clock value, or an increasing or random number included in the TX RSF attribute.

Embodiments contemplated herein include an apparatus comprising means to perform one or more elements of the method 1200. This apparatus may be, for example, an apparatus of an STA (such as a wireless device 1318 that is an STA, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of an STA (such as a memory 1322 of a wireless device 1318 that is an STA, as described herein).

Embodiments contemplated herein include an apparatus comprising logic, modules, or circuitry to perform one or more elements of the method 1200. This apparatus may be, for example, an apparatus of an STA (such as a wireless device 1318 that is an STA, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of an STA (such as a wireless device 1318 that is an STA, as described herein).

Embodiments contemplated herein include a signal as described in or related to one or more elements of the method 1200.

Embodiments contemplated herein include a computer program or computer program product comprising instructions, wherein execution of the program by a processor is to cause the processor to carry out one or more elements of the method 1200. The processor may be a processor of an STA (such as a processor(s) 1320 of a wireless device 1318 that is an STA, as described herein). These instructions may be, for example, located in the processor and/or on a memory of the STA (such as a memory 1322 of a wireless device 1318 that is an STA, as described herein).

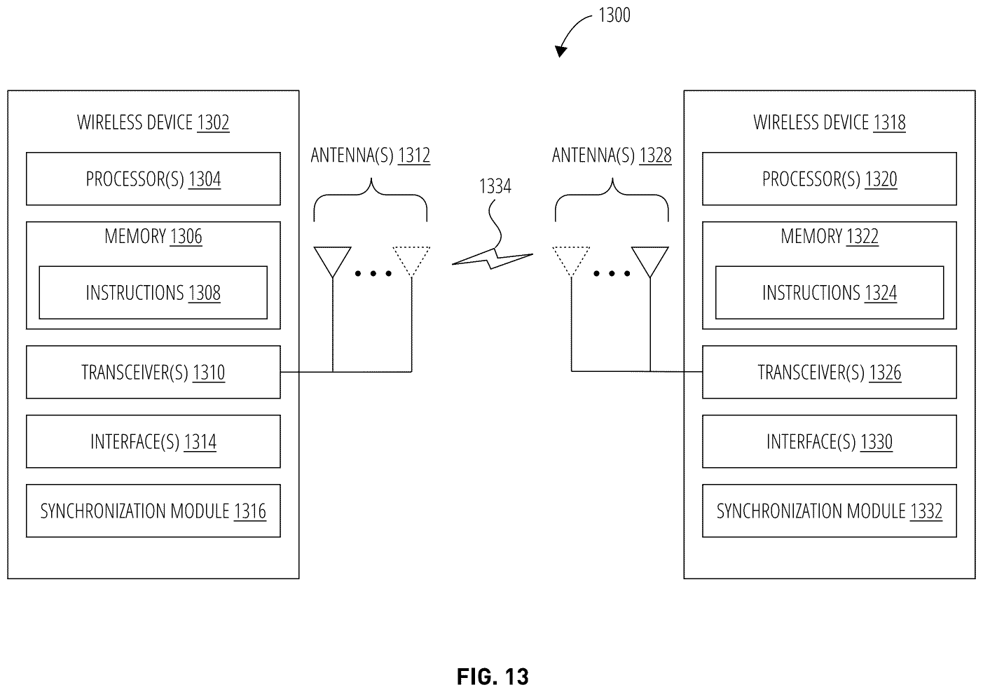

FIG. 13 illustrates a system 1300 for performing signaling 1334 between a wireless device 1302 and a wireless device 1318, according to embodiments disclosed herein. The system 1300 may be a portion of a wireless communications system as herein described. The wireless device 1302 may be, for example, an STA of a wireless communication system. The wireless device 1318 may be, for example, an access point of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter circuitry and/or receiver circuitry that use the antenna(s) 1312 of the wireless device 1302 to facilitate signaling (e.g., the signaling 1334) to and/or from the wireless device 1302 with other devices (e.g., the wireless device 1318).

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is an STA may include interface(s) 1314 such as microphones, speakers, a touchscreen, buttons, and the like in order to allow for input and/or output to the STA by a user of the STA. Other interfaces of such an STA may be made up of transmitters, receivers, and other circuitry (e.g., other than the transceiver(s) 1310/antenna(s) 1312 already described) that allow for communication between the STA and other devices and may operate according to known protocols (e.g., Wi-Fi®, Bluetooth®, and the like).

The wireless device 1302 may include a synchronization module 1316. The synchronization module 1316 may be implemented via hardware, software, or combinations thereof. For example, the synchronization module 1316 may be implemented as a processor, circuit, and/or instructions 1308 stored in the memory 1306 and executed by the processor(s) 1304. In some examples, the synchronization module 1316 may be integrated within the processor(s) 1304 and/or the transceiver(s) 1310. For example, the synchronization module 1316 may be implemented by a combination of software components (e.g., executed by a DSP or a general processor) and hardware components (e.g., logic gates and circuitry) within the processor(s) 1304 or the transceiver(s) 1310.

The synchronization module 1316 may be used for various aspects of the present disclosure, for example, aspects of FIGS. 1-12.

The wireless device 1318 may include one or more processor(s) 1320. The processor(s) 1320 may execute instructions such that various operations of the wireless device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The wireless device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The wireless device 1318 may include one or more transceiver(s) 1326 that may include RF transmitter circuitry and/or receiver circuitry that use the antenna(s) 1328 of the wireless device 1318 to facilitate signaling (e.g., the signaling 1334) to and/or from the wireless device 1318 with other devices (e.g., the wireless device 1302).

The wireless device 1318 may include one or more antenna(s) 1328 (e.g., one, two, four, or more). In embodiments having multiple antenna(s) 1328, the wireless device 1318 may perform MIMO, digital beamforming, analog beamforming, beam steering, etc., as has been described.

The wireless device 1318 may include one or more interface(s) 1330. The interface(s) 1330 may be used to provide input to or output from the wireless device 1318. For example, a wireless device 1318 that is an STA may include interface(s) 1330 such as microphones, speakers, a touchscreen, buttons, and the like in order to allow for input and/or output to the STA by a user of the STA. Other interfaces of such an STA may be made up of transmitters, receivers, and other circuitry (e.g., other than the transceiver(s) 1326/antenna(s) 1328 already described) that allow for communication between the STA and other devices and may operate according to known protocols (e.g., Wi-Fi®, Bluetooth®, and the like).

The wireless device 1318 may include a synchronization module 1332. The synchronization module 1332 may be implemented via hardware, software, or combinations thereof. For example, the synchronization module 1332 may be implemented as a processor, circuit, and/or instructions 1324 stored in the memory 1322 and executed by the processor(s) 1320. In some examples, the synchronization module 1332 may be integrated within the processor(s) 1320 and/or the transceiver(s) 1326. For example, the synchronization module 1332 may be implemented by a combination of software components (e.g., executed by a DSP or a general processor) and hardware components (e.g., logic gates and circuitry) within the processor(s) 1320 or the transceiver(s) 1326.

The synchronization module 1332 may be used for various aspects of the present disclosure, for example, aspects of FIGS. 1-12.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with an STA or AP as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with an STA or AP as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a receiver (RX) wireless device, the method comprising:
joining a first cluster comprising a second wireless device;
establishing a low-latency data link with the second wireless device;
generating an RX restricted synchronization filter (RSF) based on the low-latency data link, wherein the RX RSF identifies at least one of a service, a group, or a device;
receiving a beacon frame from a transmitter (TX) wireless device in a second cluster, wherein the beacon frame comprises a TX RSF attribute;
in response to the TX RSF attribute being compatible with the RX RSF, adopting a clock of the TX wireless device and merging with the second cluster; and
in response to the TX RSF attribute being incompatible with the RX RSF, declining to adopt the clock of the TX wireless device regardless of a rank of the TX wireless device, a cluster identifier for the second cluster, and a cluster grade for the second cluster.

2. The method of claim 1, wherein the TX RSF attribute comprises a filter length and a Bloom Filter element.

3. The method of claim 2, wherein the Bloom Filter element comprises at least one of a service name, a group identifier (ID), a group identity key, a device name, a device ID, or a device identity key.

4. The method of claim 3, wherein the Bloom Filter element further comprises Nonce.

5. The method of claim 4, wherein the Nonce can be the clock or partial clock value, or an increasing or random number included in the TX RSF attribute.

6. The method of claim 1, further comprising:
launching a new service, wherein the new service is indicated in the beacon frame as being performed in the second cluster, wherein the new service is different than a prior service the RX wireless device was performing in the first cluster;
removing the prior service from the RX RSF to cause the RX RSF to be compatible with the TX RSF; and
sending at least one of synchronization beacons or discovery beacons notifying the second wireless device of an intent to merge to the second cluster.

7. The method of claim 1, further comprising:
picking a jumping time point, wherein the jumping time point comprises a time at which the RX wireless device will adopt the clock of the TX wireless device and merge with the second cluster;
sending both synchronization beacons and discovery beacons to indicate the second cluster and the jumping time point to the second wireless device; and
merging with the second cluster at the jumping time point.

8. The method of claim 7, wherein the jumping time point is a discovery window starting time of the second cluster.

9. The method of claim 7, further comprising sending additional beacons in operating channels running low latency data paths to indicate the second cluster and the jumping time point, or sending a Schedule Update Next Available Frequency frame to indicate the second cluster and the jumping time point.

10. A method performed by a transmitter (TX) wireless device, the method comprising:
joining a first cluster of wireless devices;
sending, to a receiver (RX) wireless device in a second cluster, a beacon comprising a TX restricted synchronization filter (RSF) attribute, wherein the TX RSF identifies at least one of a service, a group, or a device; and
establishing a data link with the RX wireless device when the RX wireless device adopts a clock of the TX wireless device in response to the TX RSF attribute being compatible with an RX RSF of the RX wireless device.

11. The method of claim 10, wherein the TX RSF attribute comprises a filter length and a Bloom Filter element.

12. The method of claim 11, wherein the Bloom Filter element comprises at least one of a service name, a group identifier (ID), a group identity key, a device name, a device ID, or a device identity key.

13. The method of claim 12, wherein the Bloom Filter element further comprises Nonce.

14. The method of claim 13, wherein the Nonce can be the clock or partial clock value, or an increasing or random number included in the TX RSF attribute.

15. A wireless device comprising:
a processor; and
a memory storing instructions that, when executed by the processor, configure the wireless device to:
join a first cluster comprising a second wireless device;
establish a low-latency data link with the second wireless device;
generate an receiver (RX) restricted synchronization filter (RSF) based on the low-latency data link, wherein the RX RSF identifies at least one of a service, a group, or a device;
receive a beacon frame from a transmitter (TX) wireless device in a second cluster, wherein the beacon frame comprises a TX RSF attribute;
in response to the TX RSF attribute being compatible with the RX RSF, adopt a clock of the TX wireless device and merging with the second cluster; and
in response to the TX RSF attribute being incompatible with the RX RSF, decline to adopt the clock of the TX wireless device regardless of a rank of the TX wireless device, a cluster identifier for the second cluster, and a cluster grade for the second cluster.

16. The wireless device of claim 15, wherein the TX RSF attribute comprises a filter length and a Bloom Filter element.

17. The wireless device of claim 16, wherein the Bloom Filter element comprises at least one of a service name, a group identifier (ID), a group identity key, a device name, a device ID, or a device identity key.

18. The wireless device of claim 15, wherein the instructions further configure the wireless device to:
pick a jumping time point, wherein the jumping time point comprises a time at which the wireless device will adopt the clock of the TX wireless device and merge with the second cluster;
send both synchronization beacons and discovery beacons to indicate the second cluster and the jumping time point to the second wireless device; and
merge with the second cluster at the jumping time point.

19. The wireless device of claim 18, wherein the jumping time point is a discovery window starting time of the second cluster.

20. The wireless device of claim 18, further comprising sending additional beacons in operating channels running low latency data paths to indicate the second cluster and the jumping time point, or sending a Schedule Update Next Available Frequency frame to indicate the second cluster and the jumping time point.
